(19) United States
(12) Patent Application Publication
(10) Pub. No.: US 2014/0156562 A1
(43) Pub. Date: Jun. 5, 2014

(54) ADVERTISING MAT

(71) Applicants: Randy Taylor, Bonaire, GA (US); Bobby P. Taylor, Perry, GA (US)

(72) Inventors: Randy Taylor, Bonaire, GA (US); Bobby P. Taylor, Perry, GA (US)

(21) Appl. No.: 14/096,000

(22) Filed: Dec. 3, 2013

Related U.S. Application Data
(60) Provisional application No. 61/732,497, filed on Dec. 3, 2012.

(51) Int. Cl. G09F 19/22; G09F 7/00

(52) U.S. Cl. CPC G09F 19/22; G09F 7/00
USPC 705/500; 40/584

(57) ABSTRACT

Implementations of the advertising mat of the present disclosure include a plurality of advertisements from businesses. In some implementations, an advertising mat of the present disclosure may include advertisements from local businesses (e.g., within a certain mile radius of the advertising mat). In some implementations, an advertising mat of the present disclosure may include advertisements from any business including local, non-local, wholesale, retail, or any other business. In some implementations, an advertising mat of the present disclosure may include one or more advertisements having respective matrix barcodes (or two-dimensional codes) such as QR (Quick Response) codes. In some implementations, the one or more advertisements may include respective coupons.

### CROSS REFERENCE TO RELATED APPLICATION

This application claims the benefit of U.S. Patent Application Ser. No. 61/732,497, which was filed on Dec. 3, 2012, and is incorporated herein by reference in its entirety.

### TECHNICAL FIELD

This disclosure relates to an advertising mat.

### BACKGROUND

Existing advertising mats may be located at a retail store and advertise either the retail store or advertise products that may be purchased at the retail store. Static free mats are typically used in industrial areas. There does not exist a static free advertising mat at a business location that advertises a plurality of other businesses.

### BRIEF DESCRIPTION OF THE DRAWINGS

FIG. 1 illustrates an example implementation of an advertising mat of the present disclosure.

### DETAILED DESCRIPTION

Implementations of the advertising mat of the present disclosure include a plurality of advertisements from businesses. In some implementations, an advertising mat of the present disclosure may include advertisements from local businesses (e.g., within a certain mile radius of the advertising mat). In some implementations, an advertising mat of the present disclosure may include advertisements from any business including local, non-local, wholesale, retail, or any other business. In some implementations, an advertising mat of the present disclosure may include one or more advertisements having respective matrix barcodes (or two-dimensional codes) such as QR (Quick Response) codes. In some implementations, the one or more advertisements may include respective coupons.

In some implementations, an advertising mat of the present disclosure may be placed at the base of a gas pump. In this way, a person standing at the base of gas pump may view the advertisements on the mat while pumping gas.

In some implementations, a prospective customer may redeem a coupon advertised on an advertising mat of the present disclosure by taking a picture of the coupon with a camera, mobile telephone, tablet, smart device, or any other handheld device and display the electronic coupon (i.e., photo of the coupon) at the corresponding retailer. In some implementations, the prospective customer may forward the picture to another prospective customer and that person may also redeem the coupon as described above.

In some implementations, a prospective customer may use a two-dimensional code on the advertising mat to retrieve a coupon on the Internet.

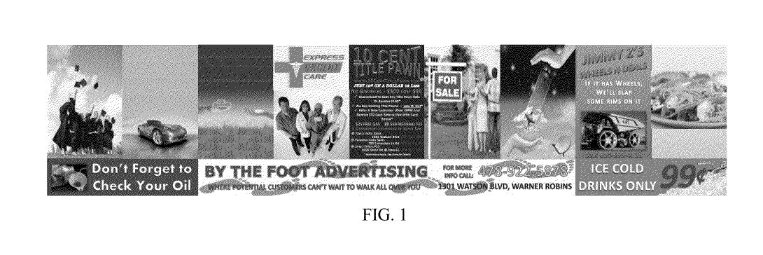

FIG. 1 illustrates an example implementation of an advertising mat of the present disclosure. In some implementations, the advertising mat may be 9 ft. long and 2 ft. wide (9′×2′). In some implementations, the advertising mat is any other dimension. In some implementations, the advertising mat may include a plurality of equally-sized rectangular (e.g. 12″×18″) advertisements and a banner advertisement extending the length of the advertising mat as shown in FIG. 1. The advertisements on the advertising mat can be the same dimension or different dimensions. The advertising mat can include any number of advertisements.

In some implementations, the advertising mat may include a metal backing.

In some implementations, the advertising mat may be comprised of multiple layers. In some implementations, the bottom layer may be a thin sheet of plastic, the middle layer may be comprised of a vinyl sheet, and the top layer may be a thin sheet of plastic which may have non-skid properties. In some implementations, the top and bottom layers may be laminated to the vinyl sheet which comprises the middle layer. In some implementations, the vinyl layer may be manufactured from a thin banner material suitable for printing an advertisement thereon.

In some implementations, the advertising mat can be secured to concrete, asphalt or other similar surfaces through the use of a water based adhesive. The adhesive can be applied to the backside of the bottom layer, which may be comprised of a thin sheet of plastic, which is then pressed onto a concrete, asphalt, or other, similar surface. In some implementations, the any suitable adhesive may be used to secure the thin sheet of plastic to a concrete, asphalt, or other, similar surface.

In another implementation, the advertising mat is comprised of a bottom layer that may be a piece of plastic or metal, a middle layer that may be comprised of vinyl, and a top layer that may be a polyurethane coating. In some implementations, the polyurethane coating may have non-skid properties. In some implementations, the polyurethane of the top layer is sprayed, rolled, or brushed onto the top side of the middle layer of vinyl. In some implementations, the polyurethane is applied to the top layer of vinyl by any suitable method. In some implementations, the middle layer is affixed to the bottom layer of plastic or metal through any suitable means such as lamination, or through the use of a suitable adhesive. In some implementations, the vinyl layer may be a thin banner material suitable for printing an advertisement thereon. In some implementations, the vinyl may be a thick banner material suitable for printing an advertisement thereon.

In some implementations, the middle layer may be manufactured from a material suitable for printing an advertisement thereon. In some implementations, the middle layer may be flexible. In some implementations, the middle layer may be comprised of a sticker having a printed advertisement on one side and an adhesive on the other. Constructing the middle layer as a sticker allows it, and thereby a top layer, to be peeled off of the bottom layer and replaced.

In some implementations, the advertising mat can be secured to concrete, asphalt or other similar surfaces through the use of an adhesive. The adhesive can be applied to the backside of the bottom layer, which may be comprised of a piece of plastic or metal, then pressed onto a concrete, asphalt, or other, similar surface.

In some implementations, the plastic or metal layer is intended to be secured to concrete, asphalt, or other similar surface for an extended period of time and the middle and top portion are intended to be replaced during a shorter period of time.

In another implementation, the advertising mat may take the form of a standard door mat. In some implementations, the door mat may be manufactured from a plastic such as polyvinyl chloride (PVC) or vinyl. In some implementations, the door mat may be manufactured from rubber or other suitable materials. In some implementations, an advertisement may be printed directly onto the top surface of the mat. In some implementation, a sticker having a printed advertisement on one side and an adhesive on the other can be placed on top of at least a portion of the door mat.

In some implementations, the door mat can be manufactured from a thick piece of material. In some implementations, the door mat can be manufactured from a thin piece of material.

In some implementations, the door mat can be secured to a concrete, asphalt or other similar surface through the use of an adhesive. The adhesive can be applied to the backside of the door mat which is then pressed onto a concrete, asphalt, or other, similar surface. In some implementations, a water based adhesive may be used. In some implementations, any suitable industrial adhesive may be used. In some implementations, any suitable adhesive may be used.

The adhesive used with some implementations of the advertising mat described herein may serve as a moisture barrier between the advertising mat, or door mat, and the concrete, asphalt, or other similar surface to which it is secured.

Reference throughout this specification to “an embodiment” or “an implementation” or words of similar import means that a particular described feature, structure, or characteristic is included in at least one embodiment of the present invention. Thus, the phrase “in an embodiment” or “an implementation” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

1. A method of advertising comprising:
placing pre-printed advertisements on an advertising mat; and
placing the advertisement mat near a gas pump.

2. The method of claim 1, where the pre-printed advertisements include advertisements from businesses within a predetermined distance of the advertising mat.

3. The method of claim 1, where the pre-printed advertisements include one or more advertisements having respective matrix barcodes.

4. The method of claim 1, where the pre-printed advertisements include one or more advertisements having respective matrix barcodes.

5. The method of claim 1, where the advertisement mat comprises a bottom layer, a middle layer, and a top layer wherein the bottom layer is a thin sheet of plastic, the middle layer is a vinyl sheet having the advertisements printed thereon, and the top layer is a thin sheet of plastic.

6. The method of claim 1, where the advertisement mat comprises a bottom layer, a middle layer, and a top layer wherein the bottom layer is a piece of metal or plastic, the middle layer is a vinyl sheet having the advertisements printed thereon, and the top layer is a polyurethane coating.

7. The advertisement mat of claim 6, wherein the middle layer is a sticker having the advertisements printed on one side and an adhesive on the other.

8. The method of claim 1, where the advertisement mat comprises a single layer, wherein the single layer is a synthetic material having an advertisement print thereon.

9. The advertisement mat of claim 8 is additionally comprised of a removable sticker layer having advertisements printed on one side and an adhesive on the other, the removable sticker layer is constructed to be affixed to the single layer.
